(19) United States
(12) Patent Application Publication
(10) Pub. No.: US 2014/0059499 A1
(43) Pub. Date: Feb. 27, 2014

(54) MOBILE TERMINAL AND DISPLAY CONTROL METHOD FOR THE SAME

(71) Applicant: Samsung Electronics Co., Ltd., Suwon-si (KR)

(72) Inventors: Taeyeon KIM, Seoul (KR); Sanghyuk KOH, Jeju-si (KR); Jihye MYUNG, Yongin-si (KR); Chihoon LEE, Seoul (KR); Hyemi LEE, Incheon (KR); Yuran KIM, Yongin-si (KR); Hyunmi PARK, Seoul (KR)

(21) Appl. No.: 13/945,229

(22) Filed: Jul. 18, 2013

(30) Foreign Application Priority Data
Aug. 27, 2012 (KR) 10-2012-0093821

(51) Int. Cl. G06F 3/0481

(52) U.S. Cl. CPC G06F 3/04812
USPC 715/862

(57) ABSTRACT

A mobile terminal and a display control method for the same are provided. The display control method enables the mobile terminal to detect hovering input of a pen and to display a different pointer according to the attribute of the hovering input position. The display control method includes detecting a hovering input, identifying a position of the hovering input, determining an attribute associated with the hovering input position; and displaying a pointer corresponding to the determined attribute at the position of the hovering input.

### CROSS-REFERENCE TO RELATED APPLICATION(S)

This application claims the benefit under 35 U.S.C. §119(a) of a Korean patent application filed on Aug. 27, 2012 in the Korean Intellectual Property Office and assigned Serial No. 10-2012-0093821, the entire disclosure of which is hereby incorporated by reference.

### TECHNICAL FIELD

The present disclosure relates to display control for a mobile terminal. More particularly, the present disclosure relates to a mobile terminal and display control method for the same that detect hovering input of a pen and display different pointers according to attributes of the hovering input position.

### BACKGROUND

Advanced smartphones employ various input recognition techniques to provide a variety of functions based on recognized input.

In particular, a mobile terminal such as a smartphone may perform, in response to one input, multiple operations such as entering a text input mode, entering a drawing input mode and providing a popup menu.

However, a user of an existing mobile terminal may identify a mode provided by an input only after actually selecting a specific position to perform mode transition. In other words, the user cannot identify possible operations associated with a specific position in advance before the user actually selects the position to perform mode transition.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and to provide at least the advantages described below. Accordingly, an aspect of the present disclosure is to provide a mobile terminal and display control method for the same that detect hovering input of a pen and display a pointer differently according to attributes of the hovering input position.

In accordance with an aspect of the present disclosure, a display control method for a mobile terminal is provided. The method includes detecting hovering input, identifying a position of the hovering input, determining an attribute associated with the hovering input position, and displaying a pointer corresponding to the determined attribute at the position of the hovering input.

The hovering input may be generated by a pen device.

The determining of an attribute may include checking whether the hovering input position is associated with an information display, and loading, when the hovering input position is associated with the information display, a pointer indicating presence of information to be displayed.

The determining of an attribute may include checking whether the hovering input position is associated with a text input or a drawing input, and loading, when the hovering input position is associated with the text input or the drawing input, a text pointer or drawing pointer according to the input attribute.

The loading of a drawing pointer may include determining, when the hovering input position is associated with the drawing input, whether the input mode is a pen mode or an eraser mode, and determining, when the input mode is the pen mode, properties of a drawing pen including one or more of a shape, a thickness and a color, and loading a pen pointer or eraser pointer corresponding to the pen mode or the eraser mode.

The determining of an attribute may include determining whether the hovering input position is associated with actions including scrolling, panning, object movement, split screen adjustment and object size change, and loading, when the hovering input position is associated with one of the actions, a pointer corresponding to the associated action.

The displaying of the pointer may include displaying the pointer at the hovering input position in conjunction with an application effect including a translucence effect, a popup window effect, an animation effect, and a slide effect.

The display control method may further include detecting a mode change input, loading setting information regarding the mode change input from mode changes, and displaying a pointer corresponding to a changed mode on the basis of the setting information.

The mode change input may be generated by a button on an input source having generated the hovering input.

In the case of a drawing input attribute, the mode changes include one or more of a change in pen properties including a type, a thickness, and a color of a drawing pen, and a transition between a pen mode and an eraser mode.

In accordance with another aspect of the present disclosure, a mobile terminal is provided. The terminal includes an input unit detecting a hovering input and generating an input signal corresponding to the hovering input, a display unit displaying information, and a control unit identifying, upon reception of an input signal from the input unit, a position of hovering input, determining an attribute associated with the hovering input position, and controlling the display unit to display a pointer corresponding to the determined attribute.

The input unit may generates an input signal on the basis of an input source for hovering input and states of a button on the input source, and wherein the control unit identifies the position of hovering input when the input source is a pen device.

The attribute is related to one or more of an information display, a text input, a drawing input, a scrolling operation, a panning operation, an object movement operation, a split screen adjustment operation, and an object size change operation.

The control unit may check whether the hovering input position is associated with an information display and controls, when the hovering input position is associated with the information display, the display unit to display a pointer indicating the information to be displayed.

The control unit may check whether the hovering input position is associated with a text input or a drawing input and controls, when the hovering input position is associated with text input or drawing input, the display unit to display a text pointer or a drawing pointer according to the input attribute.

The control unit may determine, when the hovering input position is associated with the drawing input, whether the input mode is a pen mode or an eraser mode, determines, when the input mode is a pen mode, properties of a drawing pen including one or more of a shape, a thickness and a color, and controls the display unit to display a pen pointer or an eraser pointer according to the pen mode or eraser mode.

The control unit may determine whether the hovering input position is associated with actions including scrolling, panning, object movement, split screen adjustment and object size change, and controls, when the hovering input position is associated with one of the actions, the display unit to display a pointer corresponding to the associated action.

Upon detection a mode change input, the input unit generates an input signal corresponding to the mode change input, and wherein the control unit loads setting information regarding mode changes in response to the mode change input and controls the display unit to display a pointer corresponding to a changed mode based on the setting information.

The mode change input may be generated by a button on an input source having generated the hovering input.

In the case of a drawing input attribute, the mode changes comprise one or more of a change in pen properties including one or more of a type, a thickness and a color of a drawing pen, and a transition between a pen mode and an eraser mode.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of various embodiments of the present disclosure will be more apparent from the following detailed description in conjunction with the accompanying drawings, in which:

FIG. 1 is a block diagram of a mobile terminal according to an embodiment of the present disclosure;

FIG. 2 illustrates an example of an input unit, such as the input unit of the mobile terminal of FIG. 1, according to an embodiment of the present disclosure;

FIG. 3 is a flowchart of a display control method for the mobile terminal according to an embodiment of the present disclosure;

FIG. 4 illustrates a hovering input according to an embodiment of the present disclosure;

FIG. 5 is a flowchart of an attribute determination procedure according to a first embodiment of the present disclosure;

FIGS. 6A and 6B illustrate display states according to the first embodiment of the present disclosure;

FIG. 7 is a flowchart of an attribute determination procedure according to a second embodiment of the present disclosure;

FIGS. 8A to 8C illustrate example display states according to the second embodiment of the present disclosure;

FIG. 9 is a flowchart of an attribute determination procedure according to a third embodiment of the present disclosure;

FIGS. 10A and 10B, 11, 12, and 13 illustrate example display states according to the third embodiment of the present disclosure; and

FIG. 14 illustrates example display states according to mode changes according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure is applicable to display control of a mobile terminal capable of sensing hovering input.

The present disclosure may be applied to any electronic appliance capable of sensing hovering input by a pen, such as a smartphone, a portable terminal, a mobile terminal, a Personal Digital Assistant (PDA), a Portable Multimedia Player (PMP), a note pad, a WiBro terminal, or a tablet computer.

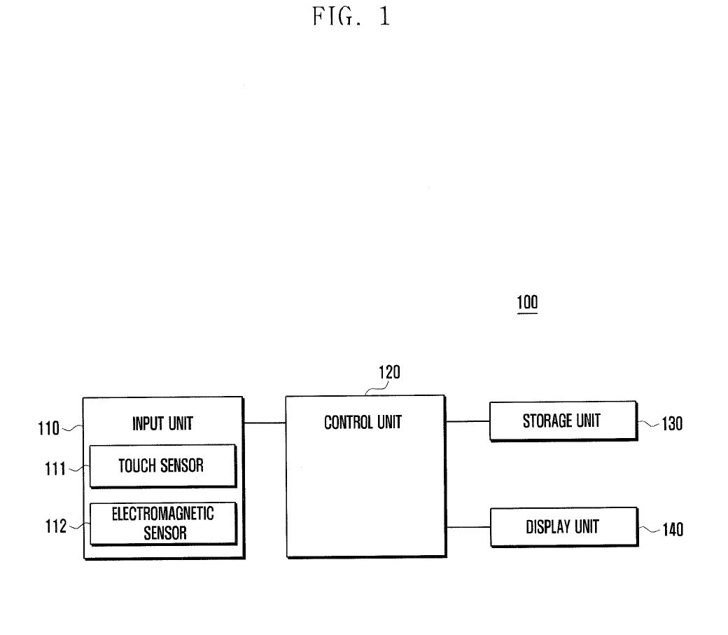

FIG. 1 is a block diagram of a mobile terminal 100 according to an embodiment of the present disclosure.

Referring to FIG. 1, the mobile terminal 100 may include an input unit 110, a control unit 120, a storage unit 130, and a display unit 140.

The input unit 110 senses user input and sends an input signal corresponding to the user input to the control unit 120. The input unit 110 may be configured to include a touch sensor 111 and an electromagnetic sensor 112.

The touch sensor 111 may sense a user touch gesture. The touch sensor 111 may take the form of a touch film, touch sheet, a touch pad or the like. The touch sensor 111 may sense touch input and send a corresponding touch signal to the control unit 120. Here, information corresponding to the sensed touch input may be displayed on the display unit 140. The touch sensor 111 may sense user touch input through various input sources. The touch sensor 111 may sense touch input through a finger or physical tool. The touch sensor 111 may sense not only direct contact, but also proximity input within a preset distance with respect to the display unit 140.

The electromagnetic sensor 112 may sense touch input or proximity input according to change in an electromagnetic field strength. The electromagnetic sensor 112 may include a coil to induce a magnetic field and may sense an object that has a resonant circuit, thereby causing a change in the characteristics of the magnetic field created by the electromagnetic sensor 112. Such an object having a resonant circuit may be an input device such as a stylus pen or digitizer pen. The electromagnetic sensor 112 may sense direct contact with the mobile terminal 100 and a proximity input or a hovering input without direct contact of the input device. Supplemental input sources such as a key, button and dial may cause different changes in the characteristics of the magnetic field created by the electromagnetic sensor 112. Hence, the electromagnetic sensor 112 may sense manipulation of the supplemental input sources.

The input unit 110 may include an input pad upon which the touch sensor 111 and the electromagnetic sensor 112 are mounted. The input unit 110 may be composed of an input pad to which the touch sensor 111 is attached in the form of a film or with which the touch sensor 111 is coupled in the form of a panel. The input unit 110 may be composed of an input pad using the electromagnetic sensor 112 on the basis of ElectroMagnetic Resonance (EMR) or ElectroMagnetic Interference (EMI). The input unit 110 may be formed with multi-layered input pads using multiple sensors for input detection.

The input unit 110 and the display unit 140 may be combined into a layered structure to form a touchscreen. For example, the input unit 110 including an input pad having the touch sensor 111 may be combined with the display unit 140 coupled with a TouchScreen Panel (TSP). Alternatively, the input unit 110 including an input pad having the electromagnetic sensor 112 may be combined with the display unit 140 having a display panel.

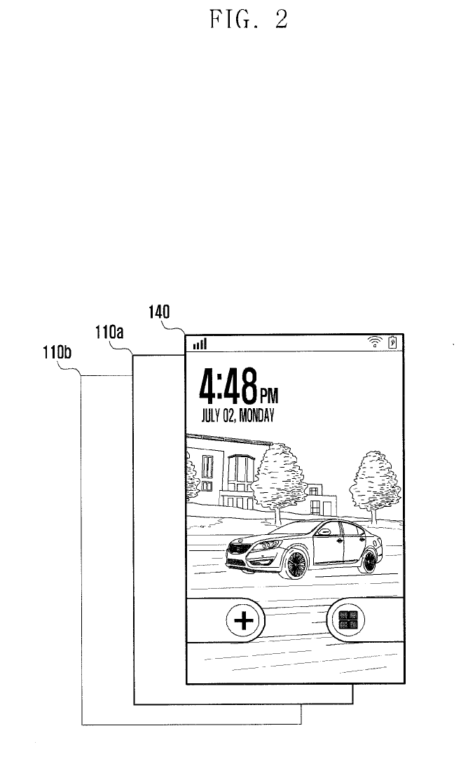

FIG. 2 illustrates an example of an input unit, such as the input unit of the mobile terminal of FIG. 1, according to an embodiment of the present disclosure.

Referring to FIG. 2, the input unit 110 may be composed of a first input pad 110a and a second input pad 110b forming a layered structure. The first input pad 110a and the second input pad 110b may be a touch or pressure pad including the touch sensor 111 or may be an electromagnetic or EMR pad including the electromagnetic sensor 112. The first input pad 110a and the second input pad 110b correspond to different inputs and may receive input respectively from the different input sources. For example, the first input pad 110a may be a touch pad capable of sensing touch input from a human body and the second input pad 110b may be an EMR pad capable of sensing a pen input. The input unit 110 may sense a multi-point input from the first input pad 110a and second input pad 110b. Here, an input pad sensing pen input may include sense states of a key, button or jog dial formed on the pen.

The input unit 110 may be combined with the display unit 140 to form a layered structure. The first input pad 110a and second input pad 110b may be placed below the display unit 140 so as to detect input generated by an icon, menu item, button or the like displayed on the display unit 140. The display unit 140 may commonly be a display panel or be a touchscreen panel combined with an input pad.

The combination between the input unit 110 and the display unit 140 depicted in FIG. 2 is purely illustrative. The types and number of input pads constituting the input unit 110, and relative arrangement of input pads and the display unit 140 may be varied according to manufacturing technology.

In particular, the input unit 110 may sense a hovering input, generate an input signal corresponding to the hovering input, and send the input signal to the control unit 120. The input unit 110 may generate an input signal together with hovering information regarding hovering input position, input source and states of a button on the input source.

The control unit 120 may control the individual components of the mobile terminal 100 to realize functions of the present disclosure. For example, when a hovering input of a pen is sensed through the input unit 110, the control unit 120 may control the display unit 140 to display a pointer corresponding to the attribute of the hovering input position.

In one embodiment, when an input signal from the input unit 110 contains hovering input information, the control unit 120 may identify the hovering input position, identify an attribute corresponding to the hovering input position, and control the display unit 140 to display a pointer corresponding to the identified attribute.

The control unit 120 may determine whether the hovering input position corresponds to an attribute of information display according to hovering input, an attribute of text input or drawing input, or an attribute of actions including scrolling, panning, object movement, split screen adjustment and object size change. When the hovering input position corresponds to the drawing input attribute, the control unit 120 may determine an input mode such as, for example, a pen mode and an eraser mode. When the pen mode is determined as the input mode, the control unit 120 may determine pen properties including a type, a thickness and a color of a drawing pen.

Operations of the control unit 120 are described in more detail later with reference to the drawings.

The storage unit 130 may store programs or commands for the mobile terminal 100. The control unit 120 may execute the programs or the commands stored in the storage unit 130.

The storage unit 130 may include one or more of various types of storage media, such as a flash memory, hard disk, multimedia or other memory card, Random Access Memory (RAM), Static Random Access Memory (SRAM), Read Only Memory (ROM), Programmable Read-Only Memory (PROM), Electrically Erasable Programmable Read-Only Memory (EEPROM), magnetic memory, magnetic disk, and optical disc.

In one embodiment, the storage unit 130 stores information regarding user input and actions corresponding to input position. For example, the storage unit 130 may store information regarding a touch input, a proximity input and a pressure input, as well as actions corresponding to the input position. For example, the storage unit 130 may further store information regarding actions corresponding to states of a button formed on an input source for generating input. The control unit 120 may identify an action corresponding to a hovering input position and determine an attribute as to the identified action on the basis of information related to actions stored in the storage unit 130.

The storage unit 130 may temporarily or semi-permanently store information on pen properties including a type, a thickness and a color of a drawing pen for drawing input according to user settings or initial settings.

The display unit 140 outputs information processed by the mobile terminal 100. For example, the display unit 140 may display guide information for the currently active application, program or service as part of the User Interface (UI) or Graphical User Interface (GUI).

The display unit 140 may be realized using one or more of display techniques based on Liquid Crystal Display (LCD), Thin Film Transistor Liquid Crystal Display (TFT-LCD), Organic Light Emitting Diodes (OLED), flexible display, and 3D display.

When the display unit 140 is layered with the touch sensor 111 and/or the electromagnetic sensor 112 of the input unit 110, it may serve as a touchscreen for touch input. In this case, the display unit 140 may serve as an input source as well as a display source.

In one embodiment, the display unit 140 displays a pointer corresponding to the attribute of a hovering input position under control of the control unit 120. The display unit 140 may display different pointers if the attribute of a hovering input position indicates information display of a pointer. The display unit 140 may display different pointers according to whether the attribute of a hovering input position indicates a text input or a drawing input. The display unit 140 may display different pointers if the attribute of the hovering input position corresponds to actions such as scrolling, panning, object movement, split screen adjustment and object size change.

The components of the mobile terminal 100 shown in FIG. 1 are examples and, therefore, components may be added or an existing component may be omitted or replaced according to the requirements of the mobile terminal.

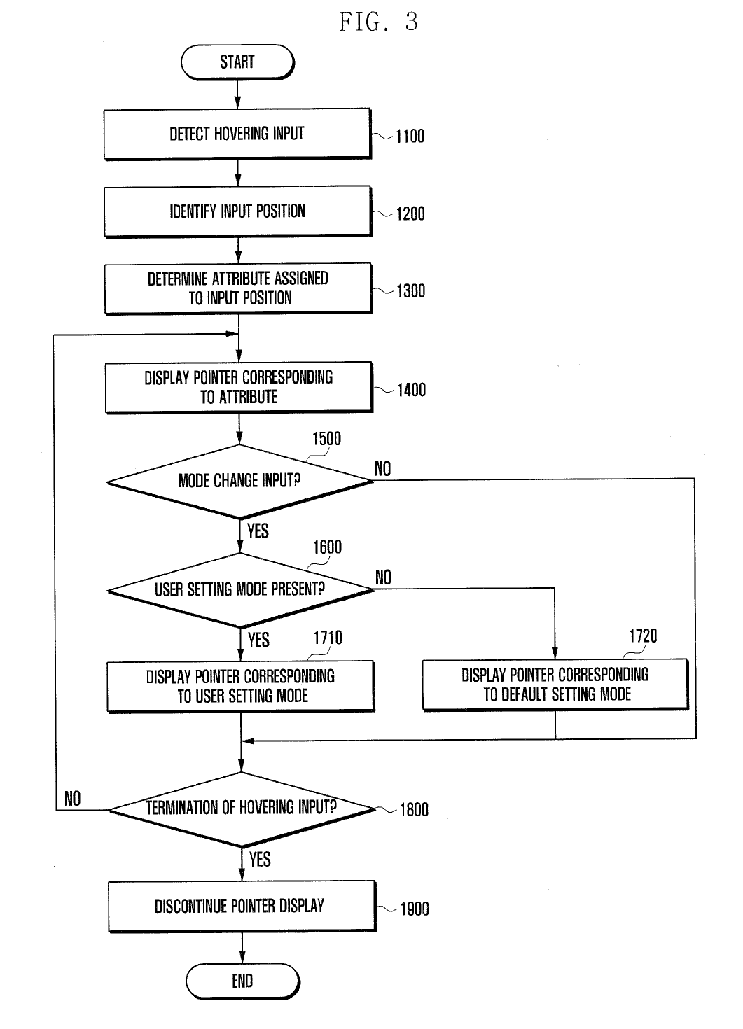

FIG. 3 is a flowchart of a display control method according to an embodiment of the present disclosure.

Referring to FIG. 3, the control unit 120 of the mobile terminal 100 detects hovering input at operation 1100.

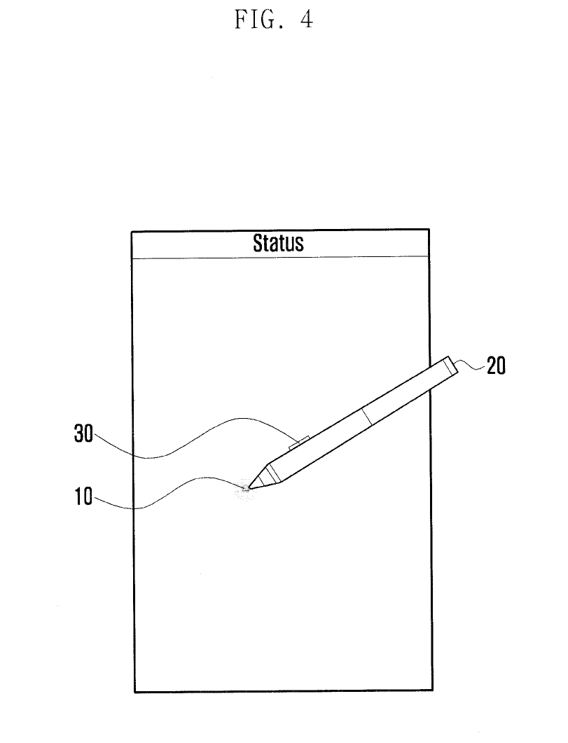

FIG. 4 illustrates a hovering input according to an embodiment of the present disclosure.

The hovering input may be generated when an input source is placed in proximity to the mobile terminal 100 as shown in FIG. 4.

The input unit 110 may sense the hovering input through one of the touch sensor 111 and the electromagnetic sensor 112. Here, the touch sensor 111 may be used to sense a hovering input by a finger (human body) and the electromagnetic sensor 112 may be used to sense a hovering input by a pen device such as a stylus pen or digitizer pen. When any of the hovering input is sensed, the input unit 110 generates a corresponding input signal and sends the input signal to the control unit 120.

The input signal may carry hovering information including hovering input position, input source, and states of a button on the input source. That is, the input unit 110 generates an input signal specific to an input device for the hovering input. For a hovering input by a pen, the input unit 110 generates an input signal reflecting states of key input, buttons and jog dials on the pen.

The control unit 120 recognizes the hovering input from the input unit 110 and may identify hovering information such as hovering input position and an input source providing the input signal. For example, referring to FIG. 4, the control unit 120 may identify a hovering input position 10, a pen 20 as an input source, and pressing of a button 30 as the basis of the input signal.

In one embodiment, upon detection of the hovering input by a pen device such as a stylus pen or digitizer pen, the control unit 120 may perform display control according to the hovering input. The control unit 120 may also perform display control according to a state of a button on the pen device.

Upon detection of the hovering input by an input source other than the pen device, the control unit 120 may perform a corresponding operation. For example, the control unit 120 may perform an operation such as function execution, call placement or reception, message transmission, character input, page transition, or multimedia playback.

In the above description, the control unit 120 performs display control upon detection of the hovering input by a pen device optionally having a button pressed. However, the control unit 120 may also perform a guiding operation upon detection of hovering input by a different input source such as a finger.

The control unit 120 identifies the hovering input position at operation 1200.

The control unit 120 identifies the hovering input position on the basis of the input signal received from the input unit 110. The hovering input position may be represented as two-dimensional coordinates defined on the display unit 140.

The control unit 120 identifies an attribute assigned to the hovering input position at operation 1300.

The control unit 120 may determine the attribute based on operations associated with the hovering input position. For example, the control unit 120 may determine whether the hovering input position is associated with information display, text input or drawing input. The control unit 120 may determine whether the hovering input position is associated with an operation such as scrolling, panning, object movement, split screen adjustment and object size change. Attribute handling is described in more detail later.

To identify the attribute corresponding to the hovering input position, the control unit 120 may refer to information related to the currently active application or service. For an application at which hovering input occurs, the control unit 120 may refer to application information including operation or attribute information describing mappings between operations and positions on the display unit 140. The application information may be prepared by the application developer and stored together with the corresponding application in the mobile terminal 100.

The control unit 120 is configured to display a pointer corresponding to the identified attribute at operation 1400.

The control unit 120 controls the display unit 140 to display a pointer corresponding to the attribute. The pointer may contain at least one of text and image. The control unit 120 may display the pointer at the hovering input position and may control the display unit 140 to display the pointer together with at least one effect such as a translucence effect, a popup window effect, an animation effect, and a slide effect.

Next, a description is given of attribute determination according to specific examples of hovering input positions and corresponding pointer displays.

### First Embodiment

In a first embodiment of the present disclosure, the control unit 120 may display different pointers depending upon the presence of the information display attribute.

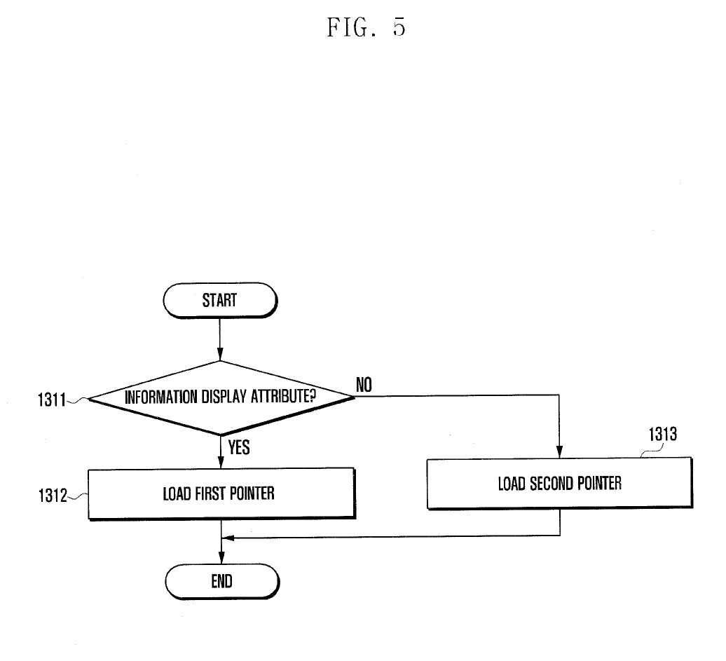

FIG. 5 is a flowchart of an attribute determination procedure according to a first embodiment of the present disclosure.

For example, referring to FIG. 5, as a part of operation 1300 for the attribute determination, the control unit 120 determines whether the hovering input position is associated with the information display attribute at operation 1311.

To this end, the control unit 120 may check the presence of an information display attribute to be displayed corresponding to the hovering input. The information to be displayed may be, for example, one of guide information, menu information, and notification or warning information. When information to be displayed is present, the control unit 120 may determine that the hovering input position is associated with the information display attribute. When information to be displayed is not present, the control unit 120 may determine that the hovering input position is not associated with the information display attribute.

When the hovering input position is associated with the information display attribute, the control unit 120 loads a first pointer at operation 1312. Here, the first pointer indicates presence of information to be displayed at the hovering input position. The control unit 120 may assign a specific shape, color or image to the first pointer to indicate the presence of information to be displayed. The shape, color and image assignable to the first pointer may be determined according to user or manufacturer settings.

When the hovering input position is not associated with the information display attribute, the control unit 120 loads a second pointer at operation 1313. Here, the second pointer indicates the absence of information to be displayed at the hovering input position and may be a regular pointer indicating a wait state. The second pointer has a different shape, color and image than the first pointer. The shape, color and image assignable to the second pointer may be determined according to user or manufacturer settings.

After the attribute determination, the control unit 120 controls the display unit 140 to display a pointer corresponding to the attribute. The control unit 120 controls the display unit 140 to display the pointer loaded according to presence of the information display attribute.

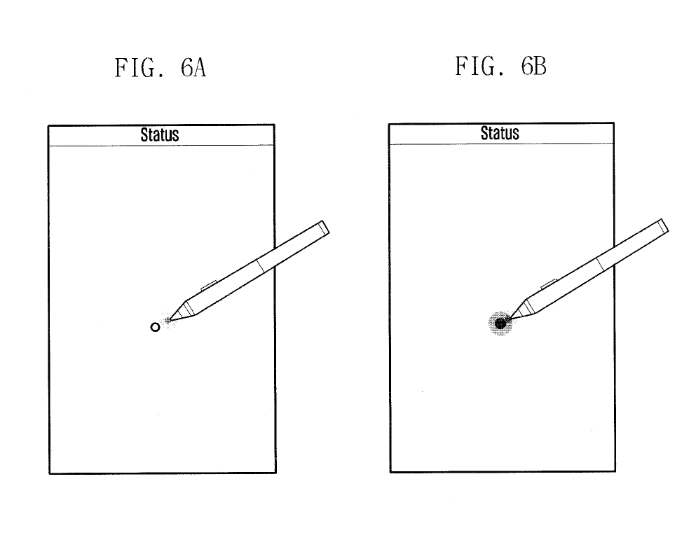

FIGS. 6A and 6B illustrate display states according to the first embodiment of the present disclosure.

When the hovering input position is associated with the information display attribute, the control unit 120 displays the first pointer. For example, referring to FIG. 6A, the first pointer may have a shape of a hollow circle. When the hovering input position is not associated with the information display attribute, the control unit 120 displays the second pointer. For example, referring to FIG. 6B, the second pointer may have a shape of a filled circle. Thus, the second pointer includes one or more of a shape, color and image that is different from the first pointer.

Hence, the user may identify presence of information to be displayed at the hovering input position based on the displayed pointer. That is, the user may determine information displayed at a specific position without actual input by bringing an input source in proximity with the mobile terminal 100 (i.e., the hovering input).

### Second Embodiment

In a second embodiment of the present disclosure, the control unit 120 may display different pointers depending upon presence of the information display attribute.

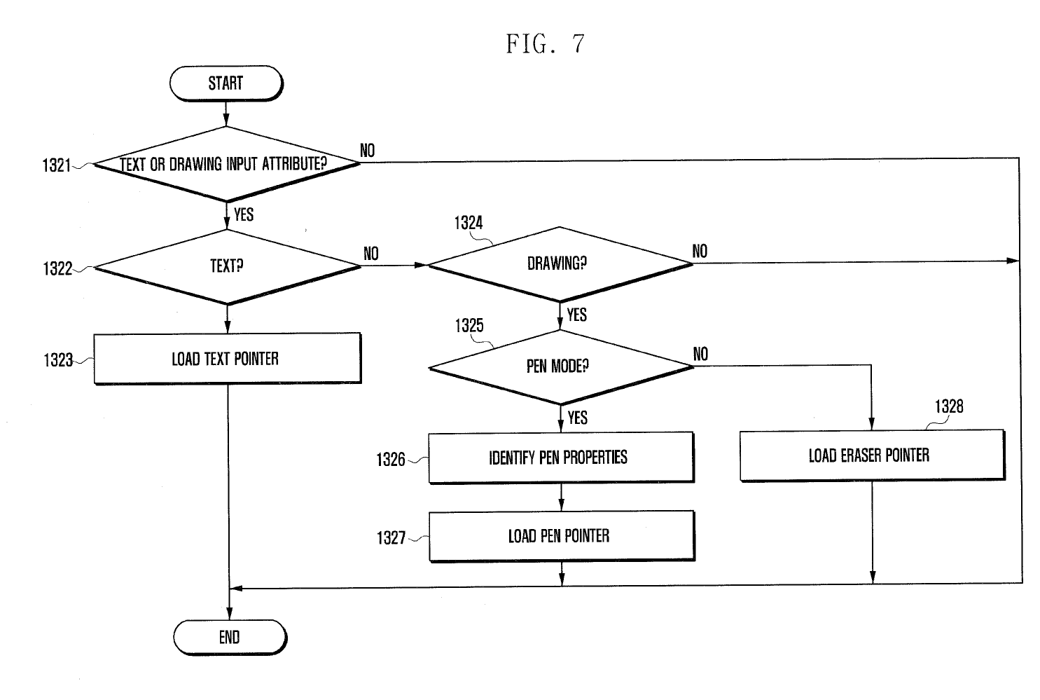

FIG. 7 is a flowchart of an attribute determination procedure according to a second embodiment of the present disclosure.

More specifically, referring to FIG. 7, as a part of operation 1300 for attribute determination, the control unit 120 determines whether the hovering input position is associated with one or more of text or drawing input attribute at operation 1321.

The control unit 120 may determine whether the hovering input position is associated with the text or drawing input attribute according to the possibility of a text input or a drawing input at the hovering input position.

Text input is possible when the hovering input position corresponds to an input region of an application, program or service requiring character input such as a text message, email message, memo or phone number, for example.

Drawing input is possible when the hovering input position corresponds to an input region of an application, program or service requiring graphical input such as a drawing, memo, picture diary or screen capture, for example.

When the hovering input position is associated with the text input attribute or the drawing input attribute, the control unit 120 determines whether the hovering input position is associated with the text input attribute at operation 1322.

That is, at operation 1322, the control unit 120 may determine that the hovering input position is associated with the text input attribute when the text input is possible at the hovering input position.

When the hovering input position is associated with the text input attribute, the control unit 120 loads a text pointer at operation 1323.

In this example, the text pointer indicates the option to provide text input at the hovering input position. The control unit 120 may assign a specific shape, color or image to the text pointer to indicate the option to provide text input. The shape, color and image assignable to the text pointer may be determined according to user or manufacturer settings.

When the hovering input position is not associated with the text input attribute, the control unit 120 determines whether the hovering input position is associated with the drawing input attribute at operation 1324.

That is, at operation 1324, the control unit 120 may determine that the hovering input position is associated with the drawing input attribute the drawing input is possible at the hovering input position.

When the hovering input position is associated with the drawing input attribute, the control unit 120 determines whether the input mode is a pen mode at operation 1325.

In the case of the pen mode input attribute, the control unit 120 may perform drawing input according to user manipulation in the pen mode and may perform drawing removal according to user manipulation in the eraser mode. The control unit 120 may identify the input mode on the basis of settings at the time of drawing input termination, user settings, or initial settings. Input mode settings may be temporarily or semi-permanently stored in the storage unit 130.

When the input mode is a pen mode, the control unit 120 identifies the pen properties at operation 1326.

The control unit 120 may determine properties of a drawing pen such as shape, thickness and color, for example. Pen properties may be identified based on one or more of settings at the time of drawing input termination, user settings, and initial settings. Pen settings may be temporarily or semi-permanently stored in the storage unit 130.

The control unit 120 loads a pen pointer corresponding to the pen properties at operation 1327.

The control unit 120 may load a pen pointer corresponding to the pen properties including one or more of shape, color, thickness and texture, for example. The pen properties including shape, color, thickness and texture of a pen pointer and may be determined according to information regarding an application, program or service providing a drawing mode or associated pointer data.

Referring back to operation 1325, when the input mode is not a pen mode, the control unit 120 loads an eraser pointer corresponding to an eraser mode at operation 1328.

The eraser pointer may have a one or more of a shape, color and image reminiscent of an actual eraser. The shape, color and image of the eraser pointer may be determined according to information regarding an application, program or service providing a drawing mode or associated pointer data.

In embodiments of the present disclosure, the text pointer, pen pointer and eraser pointer described may above differ in one or more of shape, thickness and image.

After attribute determination, the control unit 120 controls the display unit 140 to display a pointer corresponding to the attribute. The control unit 120 controls the display unit 140 to display the pointer loaded according to the text or drawing input attribute.

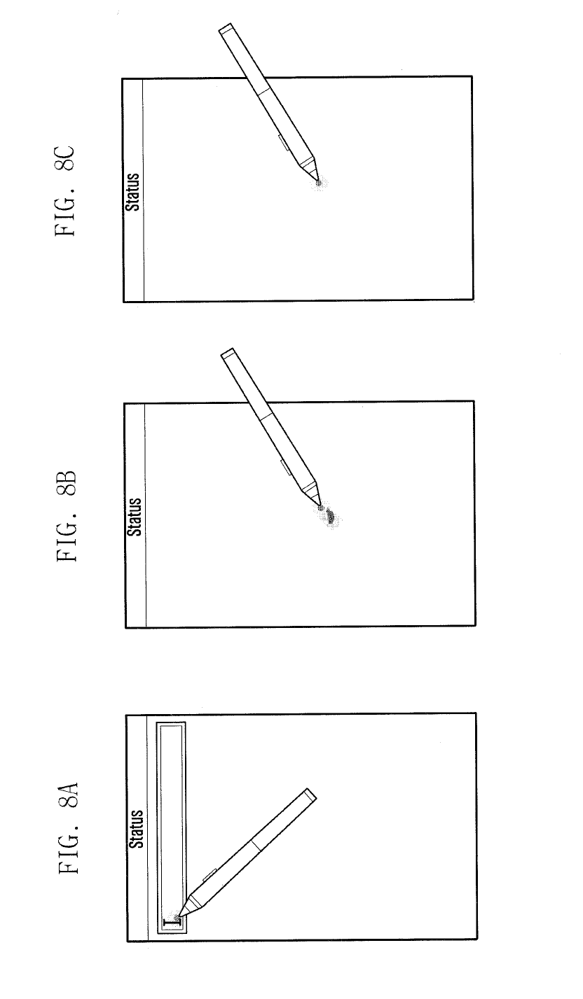

FIGS. 8A to 8C illustrate example display states according to the second embodiment of the present disclosure.

When the hovering input position is associated with the text input attribute, the control unit 120 displays a text pointer. For example, referring to FIG. 8A, the text pointer may have an I-shape. When the hovering input position is associated with the drawing input attribute and the current input mode is the pen mode, the control unit 120 displays a pen pointer corresponding to the pen properties. For example, referring to FIG. 8B, the pen pointer may have a one or more of a shape, color, thickness and texture corresponding to the pen properties. When the hovering input position is associated with the drawing input attribute and the current input mode is an eraser mode, the control unit 120 displays an eraser pointer. For example, referring to FIG. 8C, the eraser pointer may have a shape and image reminiscent of an actual eraser.

Hence, the user may recognize availability of text input or drawing input at the hovering input position based on the displayed pointer. That is, the user may determine possibility of text input or drawing input at a specific position in advance without actual input or actual drawing tool activation by placing an input source in proximity with the mobile terminal 100 (i.e., hovering input).

### Third Embodiment

In a third embodiment of the present disclosure, the control unit 120 may display different pointers according to the attribute of actions.

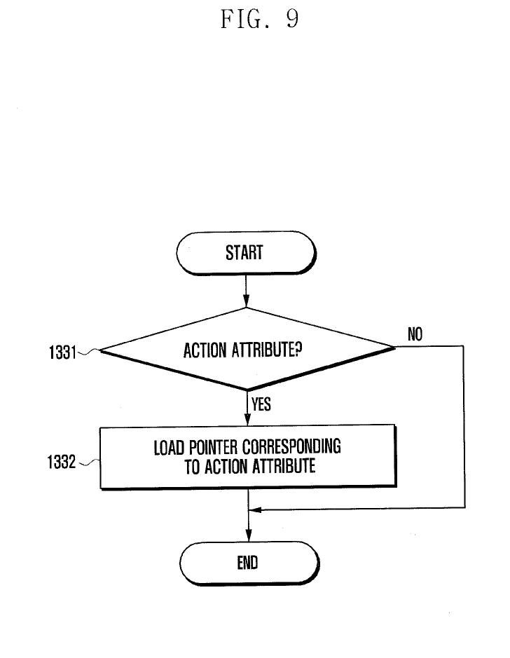

FIG. 9 is a flowchart of an attribute determination procedure according to a third embodiment of the present disclosure.

More specifically, referring to FIG. 9, as part of the attribute determination at operation 1300, the control unit 120 determines whether the hovering input position is associated with actions at operation 1331.

The control unit 120 may determine whether the hovering input position indicates a position for scrolling or panning. The control unit 120 may also determine the hovering input position indicates a position at which a movable object is present, indicates a position for adjustment of split screens, or indicates a position for an object size change.

Upon determination result, the control unit 120 may determine whether the hovering input position is associated with at one or more actions including scrolling, panning, object movement, split screen adjustment, and object size change, for example.

When the hovering input position is associated with actions, the control unit 120 loads a pointer corresponding to the attribute of actions at operation 1332.

The control unit 120 may check the direction of the action. That is, the control unit 120 may determine applicable directions for scrolling or panning. The control unit 120 may also determine applicable directions for an object movement, a split screen adjustment, or an object size enlargement or reduction.

For example, when a portion of content is displayed on the display unit 140 and the screen is scrollable in the up direction and the down direction, the control unit 120 may determine “up” and “down” as applicable directions. When the screen is split vertically and the spilt screens are adjustable in the left or right direction, the control unit 120 may determine “left” and “right” as applicable directions.

For a particular action, a determination of applicable directions may be performed as part of attribute determination. In this case, the control unit 120 may skip determination of applicable directions.

The control unit 120 may load a pointer corresponding to the attribute or direction of the action. The control unit 120 may load a pointer having one or more of a shape, color and image corresponding to the attribute or direction of the action.

In embodiments of the present disclosure, the pointers for actions described above differ in one or more of shape, thickness and image according to one or more of attributes, action, and a direction of the actions.

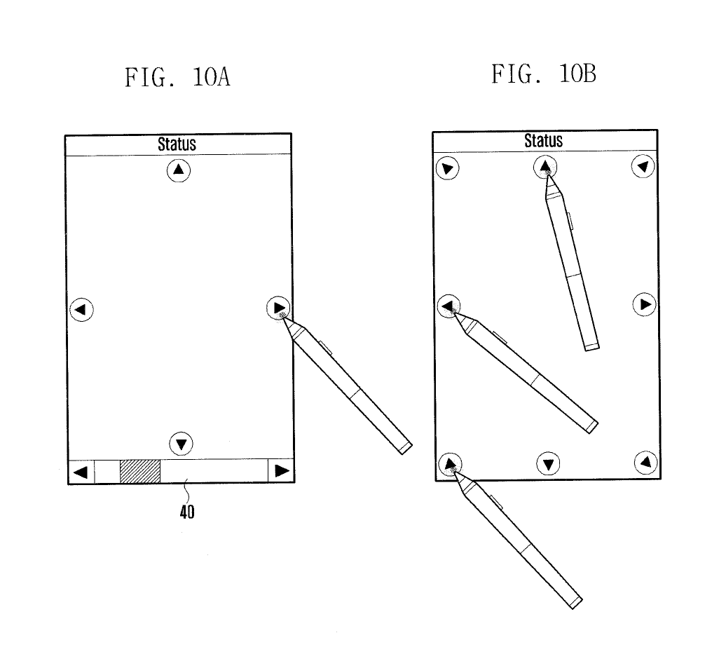

FIGS. 10A and 10B, 11, 12, and 13 illustrate example display states according to the third embodiment of the present disclosure.

After the attribute determination, the control unit 120 controls the display unit 140 to display a pointer corresponding to the attribute.

For example, referring to FIG. 10A, when the hovering input position indicates a position for scrolling, the control unit 120 may display a pointer composed of an image indicating scrollable directions. When a portion of content is displayed on the display unit 140 and scrolling to the right is possible, the control unit 120 may display a pointer indicating the option to scroll to the right. Here, the control unit 120 may control the display unit 140 to display a scrollbar 40 together with the pointer.

As another example, referring to FIG. 10B, when the hovering input position indicates a position for panning, the control unit 120 may display a pointer composed of an image indicating panning directions. When a touch, proximity or pressure input is sensed at the hovering input position, the control unit 120 may perform scrolling or panning in a direction according to the input position.

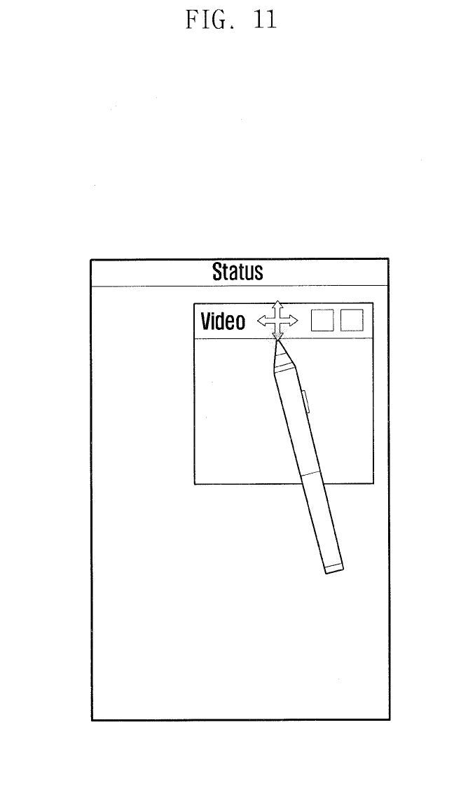

Referring to FIG. 11, when the hovering input position indicates a position at which a movable object is present, the control unit 120 may display a pointer composed of an image indicating object movability (i.e., displacement). Here, the pointer may have an image of an arrow indicating directions in which the object may be moved.

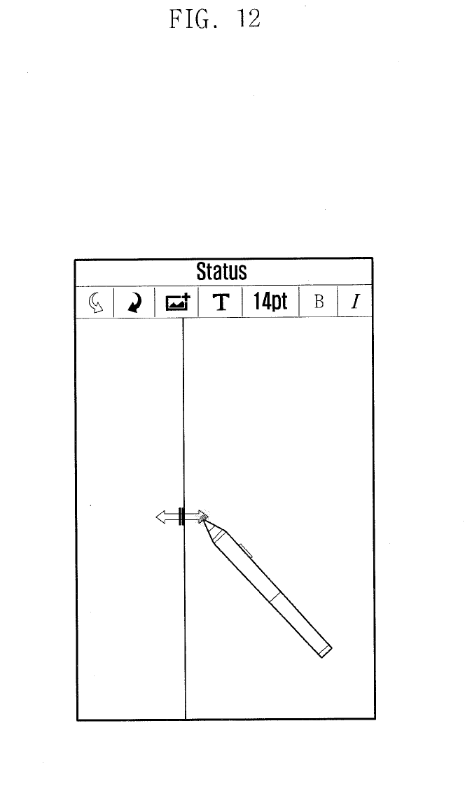

Referring to FIG. 12, when the hovering input position indicates a position for split screen adjustment, the control unit 120 may display a pointer composed of an image indicating the adjustability of split screens. Here, the pointer may have an image of an arrow indicating the adjustable directions of split screens.

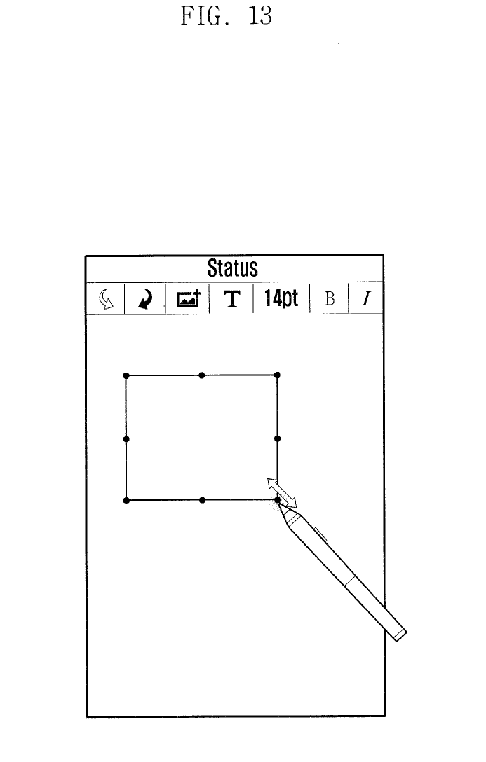

Referring to FIG. 13, when the hovering input position indicates a position for object size change, the control unit 120 may display a pointer composed of an image indicating size adjustment of an object. Here, the pointer may be an image of an arrow indicating directions of object size enlargement and reduction.

In the embodiments described above, the control unit 120 may display the pointer together with at least one effect such as a translucence effect, a popup window effect, an animation effect, and a slide effect, for example.

Referring back to FIG. 3, the control unit 120 checks whether mode change input is detected at operation 1500.

The input unit 110 may generate different input signals according to state changes of a button on the input source having generated the hovering input.

The control unit 120 may detect a change in hovering input information through an analysis of an input signal from the input unit 110. In an embodiment, for the hovering input by a pen, the control unit 120 may detect a mode change input when the analysis of an input signal indicates that a button on the pen has been manipulated.

When mode change input is detected, the control unit 120 checks whether a user setting mode is present at operation 1600.

A mode change input may cause a change in pen properties such as, for example, one or more of a type, a thickness and a color of the pen having generated the hovering input. The mode change input may be caused by transition between the pen mode and the eraser mode, for example. The user setting mode may be composed of one or more modes and the sequence of transitions between the modes may be specified by the user. The control unit 120 may obtain information on user setting modes and transitions therebetween. The pointers may differ in type, color and image as assigned to the user setting modes.

The control unit 120 may receive information on a user setting mode from the user.

When no user setting mode information is received from the user, the control unit 120 may obtain information on a default setting mode. Information on the default setting mode may be pre-stored in the storage unit 130 by the manufacturer.

When a user setting mode is present, the control unit 120 displays a pointer corresponding to the user setting mode at operation 1710.

The control unit 120 may assign a specific shape, color and image to the pointer corresponding to the user setting mode. The shape, color and image assignable to the pointer may be determined according to user settings.

In the case that the user setting mode is composed of one or more sub-modes such that when a mode change input is detected, the control unit 120 may transition between the sub-modes and display a pointer corresponding to the current sub-mode. Here, pointers corresponding to the sub-modes may differ in one or more of a shape, thickness and image.

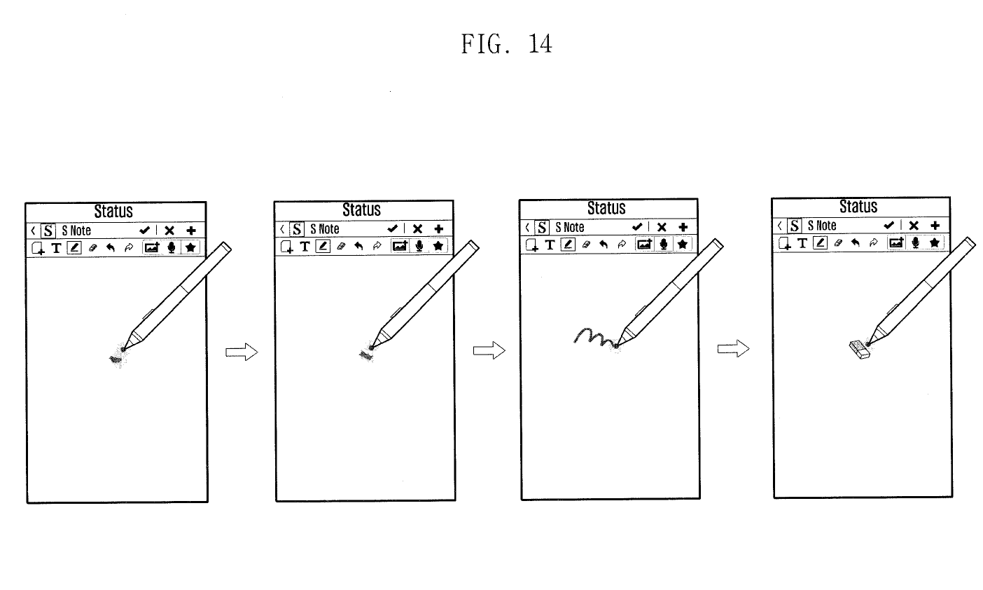

FIG. 14 illustrates example display states according to mode changes.

Referring back to operation 1600, when a user setting mode is not present, the control unit 120 displays a pointer corresponding to a default setting mode at operation 1720.

The control unit 120 determines whether hovering input is terminated at operation 1800.

When the hovering input is sustained, the input unit 110 may generate an input signal corresponding to the hovering input and send the input signal to the control unit 120 at regular intervals.

When the hovering input is terminated, the input unit 110 does not generate a corresponding input signal to be sent to the control unit 120. When an input signal with hovering information is not received for a preset time, the control unit 120 may determine that the hovering input is terminated.

When the hovering input is terminated, the control unit 120 discontinues display of the pointer at operation 1900.

Upon detection of hovering input termination, the control unit 120 may control the display unit 140 not to display the pointer.

In a feature of the present disclosure, the mobile terminal and display control method for the same detect hovering input and present current operating mode or available operating modes associated with the hovering input position, notifying the user of currently available modes in advance.

In addition, the mobile terminal and display control method for the same enable the user to identify an available mode in advance without making actual mode transition. Hence, the user may use the mobile terminal in a more efficient manner without unnecessarily transitioning between modes.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A display control method for a mobile terminal, the method comprising:
detecting a hovering input;
identifying a position of the hovering input;
determining an attribute associated with the hovering input position; and
displaying a pointer corresponding to the determined attribute at the position of the hovering input.

2. The display control method of claim 1, wherein the hovering input is generated by a pen device.

3. The display control method of claim 1, wherein the determining of the attribute comprises:
checking whether the hovering input position is associated with an information display; and
loading, when the hovering input position is associated with the information display, a pointer indicating presence of information to be displayed.

4. The display control method of claim 1, wherein the determining of an attribute comprises:
checking whether the hovering input position is associated with a text input or a drawing input; and
loading, when the hovering input position is associated with the text input or the drawing input, a text pointer or drawing pointer according to the input attribute.

5. The display control method of claim 4, wherein the loading of a drawing pointer comprises:
determining, when the hovering input position is associated with the drawing input, whether the input mode is a pen mode or an eraser mode; and
determining, when the input mode is a pen mode, properties of a drawing pen including one or more of a shape, a thickness and a color; and
loading a pen pointer or eraser pointer corresponding to the pen mode or the eraser mode.

6. The display control method of claim 1, wherein the determining of an attribute comprises:
determining whether the hovering input position is associated with actions including scrolling, panning, object movement, split screen adjustment and object size change; and
loading, when the hovering input position is associated with one of the actions, a pointer corresponding to the associated action.

7. The display control method of claim 1, wherein the displaying of the pointer comprises displaying the pointer at the hovering input position in conjunction with an application an effect including a translucence effect, a popup window effect, an animation effect, and a slide effect.

8. The display control method of claim 1, further comprising:
detecting a mode change input;
loading setting information regarding the mode change input from mode changes; and
displaying a pointer corresponding to a changed mode on the basis of the setting information.

9. The display control method of claim 8, wherein the mode change input is generated by a button on an input source having generated the hovering input.

10. The display control method of claim 9, wherein, in the case of a drawing input attribute, the mode changes include one or more of a change in pen properties including a type, a thickness, and a color of a drawing pen, and a transition between a pen mode and an eraser mode.

11. A mobile terminal comprising:
an input unit detecting a hovering input and generating an input signal corresponding to the hovering input;
a display unit displaying information; and
a control unit identifying, upon reception of an input signal from the input unit, a position of hovering input, determining an attribute associated with the hovering input position, and controlling the display unit to display a pointer corresponding to the determined attribute.

12. The mobile terminal of claim 11, wherein the input unit generates an input signal on the basis of an input source for hovering input and states of a button on the input source, and wherein the control unit identifies the position of hovering input when the input source is a pen device.

13. The mobile terminal of claim 11, wherein the attribute is related to one or more of an information display, a text input, a drawing input, a scrolling operation, a panning operation, an object movement operation, a split screen adjustment operation, and an object size change operation.

14. The mobile terminal of claim 11, wherein the control unit checks whether the hovering input position is associated with an information display and controls, when the hovering input position is associated with the information display, the display unit to display a pointer indicating the information to be displayed.

15. The mobile terminal of claim 11, wherein the control unit checks whether the hovering input position is associated with a text input or a drawing input and controls, when the hovering input position is associated with text input or drawing input, the display unit to display a text pointer or a drawing pointer according to the input attribute.

16. The mobile terminal of claim 15, wherein the control unit determines, when the hovering input position is associated with the drawing input, whether the input mode is a pen mode or an eraser mode, determines, when the input mode is a pen mode, properties of a drawing pen including one or more of a shape, a thickness and a color, and controls the display unit to display a pen pointer or an eraser pointer according to the pen mode or eraser mode.

17. The mobile terminal of claim 11, wherein the control unit determines whether the hovering input position is associated with actions including scrolling, panning, object movement, split screen adjustment and object size change, and controls, when the hovering input position is associated with one of the actions, the display unit to display a pointer corresponding to the associated action.

18. The mobile terminal of claim 11, wherein the input unit, upon detection of a mode change input, generates an input signal corresponding to the mode change input, and wherein the control unit loads setting information regarding mode changes in response to the mode change input and controls the display unit to display a pointer corresponding to a changed mode based on the setting information.

19. The mobile terminal of claim 18, wherein the mode change input is generated by a button on an input source having generated the hovering input.

20. The mobile terminal of claim 19, wherein, in the case of a drawing input attribute, the mode changes comprise one or more of a change in pen properties including one or more of a type, a thickness and a color of a drawing pen, and a transition between a pen mode and an eraser mode.

21. At least one non-transitory processor readable medium for storing a computer program of instructions configured to be readable by at least one processor for instructing the at least one processor to execute a computer process for performing the method as recited in claim 1.
